(19) United States
(12) Patent Application Publication
(10) Pub. No.: US 2003/0031034 A1
(43) Pub. Date: Feb. 13, 2003

(54) Programmable power supply

(76) Inventors: Edward T. Rodriguez, Winchester, MA (US); Gary R. Fuchs, Princeton, MA (US)

Correspondence Address: CESARI AND MCKENNA, LLP, 88 BLACK FALCON AVENUE, BOSTON, MA, 02210, US

(21) Appl. No.: 10/215,281

(22) Filed: Aug. 8, 2002

Related U.S. Application Data
(60) Provisional application No. 60/310,994, filed on Aug. 8, 2001.

(51) Int. Cl. H02M 1/12

(52) U.S. Cl. 363/45

(57) ABSTRACT

A high density, multiple output switching power supply having internal, but externally accessible, mechanical programmability means, or computer generated programmability, whereby a mass-produced, fully tested standard base model can be stocked and reprogrammed at the distributor locations into any one of a multitude of substantially different models that is then delivered directly to the end user.

### CROSS-REFERENCE TO RELATED APPLICATIONS

The present application claims the benefit of U.S. Provisional Patent Application Serial No. 60/310,994, which was filed on Aug. 8, 2001, by the same inventors and with the same title as the present application, and this provisional application is hereby incorporated herein by reference.

### BACKGROUND OF THE INVENTION

1. Field of the Invention

The present invention is related to power supplies, and more particularly to programmable, modular power supplies designed to meet industry standard specifications and approvals.

2. Background Information

For the 35 years that switching power supplies have been generally available, there has been a continuing interest in devising means to more quickly design custom or semi custom configuration. Without such means, custom designs have typically required substantial cost and development time and have furthermore resulted in products that exhibited performance anomalies until production histories were established.

While manufacturers would ideally design and produce standard products and keep them in inventory for prompt delivery, it has become a virtual economic impossibility for firms to inventory the vast number which might be required. As a result there is typically a lead time of 2 to 8 weeks for delivery of catalog items. This is especially true for power supplies rated over 250 watts

The situation is quite analogous to the furniture industry. If one seeks to buy a sofa, the process typically involves choosing the design but waiting 6-8 weeks for a sofa with a chosen fabric. It would be impossible for the store to inventory the sofa in every possible fabric

In the early 1980's commercial products were introduced which were based on configurable modules. That is, a series of standard modules were designed with the intent that these standard elements could be quickly put together as building blocks, in accordance with certain guidelines, to create a complete, custom unit. Since that time over a dozen firms have introduced such design and assembly techniques, known as “modular configurables.”

Modular configurable supplies were offered originally by PowerTec, PowerOne and Advance Power. Later suppliers include Astec's “MVP” (a trademark of Astec) series, Lambda's “Ultraflex” (a trademark of Lambda) series, Magnetek, and Artesyn. Vicor has for some time marketed a family of modular configurables based on assemblages of its pre-manufactured DC converter modules.

Adjustable or programmable power supplies have been available for decades. Bench mounted laboratory supplies are commonly available with potentiometers to adjust voltages and current limits. More recently such supplies have become available with means for digitally programming voltage or current from an external computer. Very recently, certain DC-DC converter modules known as voltage regulator modules (VRM's) have been introduced. Typically used to power advanced microprocessors, the output voltage of VRM's are programmed by an external means, for example from a microprocessor in order to optimize the microprocessor performance.

In a related area, digital potentiometers are now available. Such chips simulate conventional rotary, mechanical potentiometers. However they required an external voltage to function and typically must be reset. Therefore, they have limitations as a means to create power supply programmability.

A limitation of the known programmable supplies and related electronics is their narrow range of applications. They have not found used as the primary power management system in what might be called mainstream power supplies for a broad range of electronic systems. One reason is that these known supplies inherently require a level of technical support sophistication incompatible with simple “point of sale” programmability. Other reasons include cost and packaging limitations. The present invention is directed, among other objectives, toward relieving these limitations.

Another limitation is that seemingly fully adjustable or digitally programmable laboratory power supplies do not incorporate adjustability of all the characteristics necessary in a commercial OEM multi-output power supply. (OEM, for “Original Equipment Manufacture,r” is a term of art given to equipment sold for inclusion into a separate final piece of equipment for the end user.

More recently the industry has been demanding a new class of performance capabilities known as redundancy or “hot swap” in which the unit can be replaced without shutting down power.

Modular configurable products do not incorporate this hot-swap capability. Furthermore as more and more firms produce “off shore,” it has become costly to stock the modules necessary to configure the wide variety of power supplies, and therefore off the shelf supplies configured supplies are rare. This is in conflict with the just-in-time delivery pressures of industry.

The broad electronic, computer system application require a broad range of different power voltages, currents, and power levels. Those applications typically are supplied with a number of prior art modular power supplies with different fixed outputs. There is a variety of modules each with an output voltage and current, and a chassis is provides for mounting a number of these different modules. The users specifies the modules needed and mounts them in the chassis. The different outputs are then fed to the electronic systems involved. No one heretofore has designed a single module with enough outputs at given power levels such that one programmable module provides for the needs of a broad range of electric, computer system.

A result is that available modular configurable power supplies have failed to penetrate the “commodity” use for general electronic systems. There is market need that the present invention addresses for a better alternative to customization without the attendant cost, size and performance limitations.

It is normal industry practice to have separate, but perhaps similar designs, to accommodate all the possible combinations of characteristics as just outlined. With receipt of a purchase order, a firm might then take the process for a basic unit and modify for the appropriate changes required. In practice, the achievement of this goal on a timely basis is very difficult even though it is seemingly straightforward. Furthermore, it is known in the industry that each time a change, however small, is introduced into a production line, the possibility of error increases.

Modular power supplies have been the subject of many patents over the years. One such patent, U.S. Pat. No. 4,569,009 describes basic techniques for programming voltage levels, and points out the need to concurrently program other parameters, e.g. over-voltage protection and “good” DC thresholds. U.S. Pat. No. 5,103,110 describes techniques for selecting output voltage or current characteristics. U.S. Pat. No. 5,917,311 describes methods—of employing arrays of resistors in divider networks to select discrete voltage outputs. U.S. Pat. No. 4,193,104 describes selectable voltage dividers circuits to select over-voltage circuit protection as noted in U.S. Pat. No. 4,569,009, above.

One major growth market for configurable, programmable power is for networking and communications equipment. Two sets of power supply performance specifications have been developed for these applications.

One set addresses signals and diagnostics. That is a power supply is expected to provide certain signals indicating its operating status and incorporate protection against certain fault conditions.

The second set addresses voltage and current ratings. These ratings have many variations (a sofa analogy where the type of sofa and all the variations in fabric make stocking all the variations uneconomical—therefore there is typically a very long waiting period) making it difficult to meet delivery times for any given model. Power supply variations are much more complex than the variations in the sofa analogy making for a lengthy delivery time for a specific supply.

It is an object of the present invention to provide a single manufacturing platform from which a single, pre-produced, pre-tested, inventoried model can be “programmed” into hundreds of different models by a relatively unskilled person. The approach is for the base model to be stocked by distributors, who then configure the base model to meet the desired needs of the user and deliver that model directly to the user from stock.

Virtually 100% of power supplies sold today also must be tested and approved by Underwriters Labs. It is an object of the present invention to provide a platform where the programming methodology does not affect the approval rating. That is, once the standard model is approved, all variations are correspondingly approved. This obviates the expense of individual supply configuration approvals.

One objective of the present invention is to identify the most popular base model and the multitude of popular different models and how they would vary from the base model. This versatility requires that the base model be “over-designed,” and this over-design is an objective of the present invention.

More specifically a prior art practice in power supply design is to optimize the design of transformers, outputs rectifiers, output chokes, and output filter capacitors in accordance with whether such outputs are specifie, for example, at 5v, 3.3V, 2.2V etc. or for current ratings 70 amps, 50 amps, 30 amps etc. It is an objective of the proposed invention to achieve those ends without this narrow optimization. That is, the present invention provides a baseline design, capable of the highest voltages, power ratings, and the highest currents specified. This embodiment is defined as “overdesigned” for its intended configurations.

All subsequent programming changes are implemented to only provide equal or lower voltages power, or current ratings from that baseline unit.

Furthermore, it has long been an issue for power supply manufacturers that, after modifying a design, they usually go through the cost and time delay of submitting a sample, or technical data to Underwriters Laboratories or similar safety-certification agency to validate certain of the ratings.

The approval protocol of Underwriters laboratories is such that an approved unit can be manufactured and modified into any number of versions and sold as a listed unit item as long as a baseline unit has been approved and the modifications fall within specifically documented lower voltage and/or current ratings.

The proposed invention provides an “overdesigned” base unit meeting the UL protocols. The hundreds of possible reprogrammed modifications are all documented to be of a lower voltage and/or current rating so all the programmed versions are automatically UL approved.

In other words it is an object of the present invention that programmability maintains UL approval wherein supplies made in accordance with the present invention are essentially invisible to the end customer as if the supplies were design-optimized and manufactured expressly for that user.

### SUMMARY OF THE INVENTION

In view of the foregoing background discussion, the present invention recognizes that a five output, hot swappable, single module power supply will satisfy a large portion of the general computer, networking electronics system needs. Moreover, a single module will allow cost to be driven down by volume production, reliability improved by testing and over-designing one design, and availability improved as distributors need only stock one module.

Programming of all virtual modules is done by subminiature, surface mounted digi-switches, accessible from outside the unit Repositioning of the switches requires a miniature tool, thereby eliminating the possibility of inadvertent manual change. A baseline unit, a base model, is mass produced and inventoried with all switches in a particular position, constituting the most popular model. The base model is stocked at distributors who then program the base model to the specifications of the user and deliver that unit to the user substantially directly from stock.

While the subminiature switches are accessible for purpose of programmability, they become inaccessible once the power supply module is installed in a system enclosure, thereby meeting an objective of non-adjustability by an end user during system operation.

An order for any one of the many combinations is produced simply by changing switch positions. The result is virtual instant delivery of any one of a large number of models while still exhibiting instant UL approval, the predictability of a mass produced item and the features of a highly customized unit.

Those skilled in the art may also recognize that various combinations of switches and the resistors those switches select can in certain circumstances be replaced by integrated circuits such as the DS1809 non volatile digital potentiometer, made by Dallas Semiconductor.

In one preferred embodiment the power supply is design to exhibit what is viewed as the most modular configuration with incorporating all of the size and performance benefit deemed most desirable.

While the overall circuitry does not incorporate modules or DC converters, the circuitry is segmented to perform as though there are separate modules. For our purposes we will call them virtual modules In other words there are separate control loops where appropriate. Those skilled in the art are familiar with that approach.

It will be appreciated by those skilled in the art that although the following detailed description will proceed with reference being made to illustrative embodiments, the drawings, and methods of use, the present invention is not intended to be limited to these embodiments and methods of use. Rather, the present invention is of broad scope and is intended to be defined as only set forth in the accompanying claims.

### BRIEF DESCRIPTION OF THE DRAWINGS

The invention description below refers to the accompanying drawings, of which:

FIG. 1 is a partial schematic showing switch programmability;

FIG. 2 is an isometric drawing of a power supply incorporating one embodiment the present invention;

FIG. 3 is a functional drawing showing the programmability of one embodiment of the present invention;

FIG. 4 is a schematic with an embodiment of the present invention; and

FIG. 5 is a circuit diagram of a programmable resistor network.

### DETAILED DESCRIPTION OF ILLUSTRATIVE EMBODIMENTS

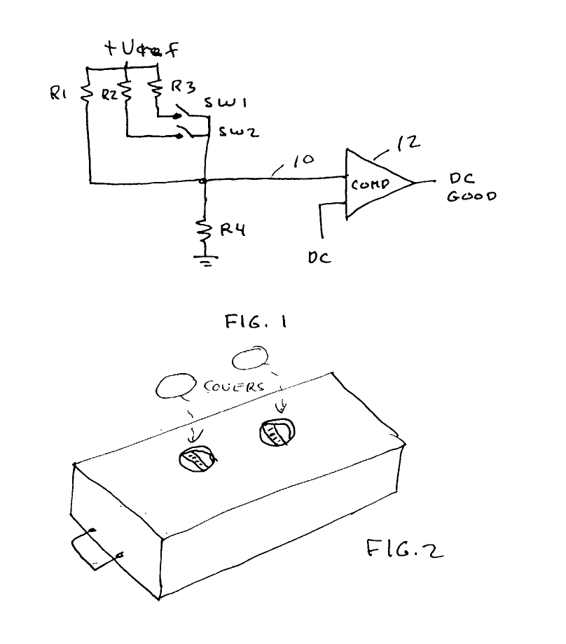

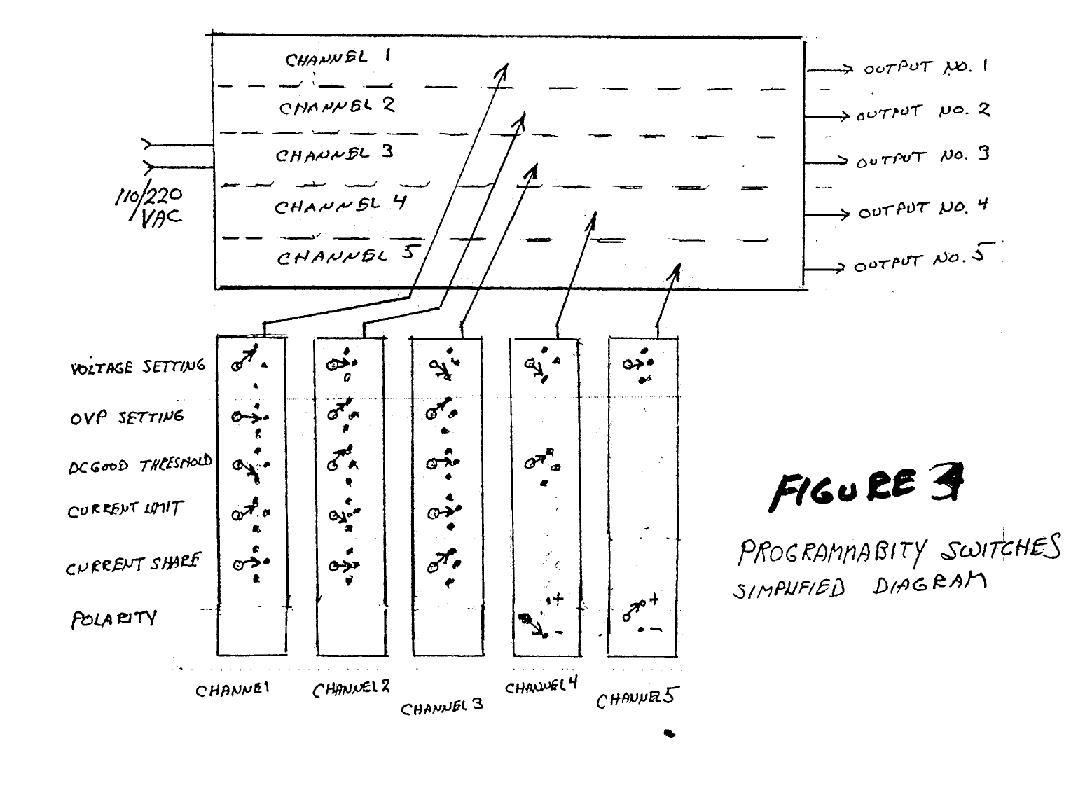

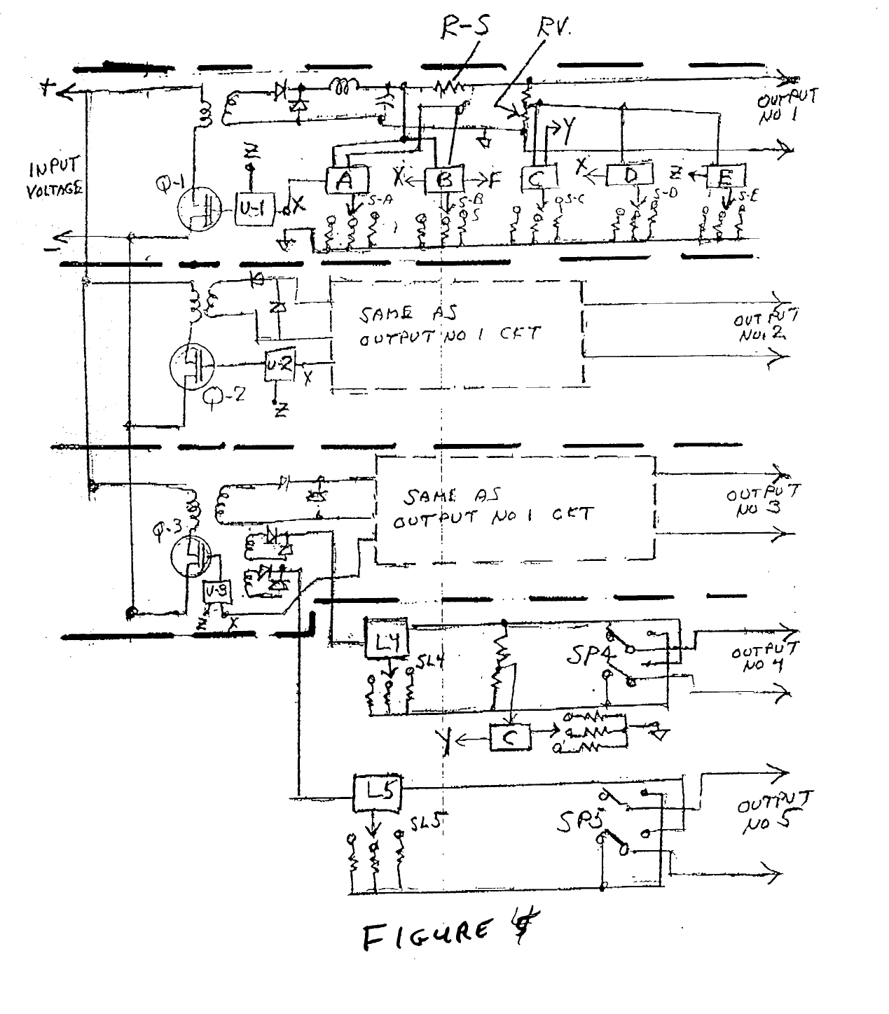

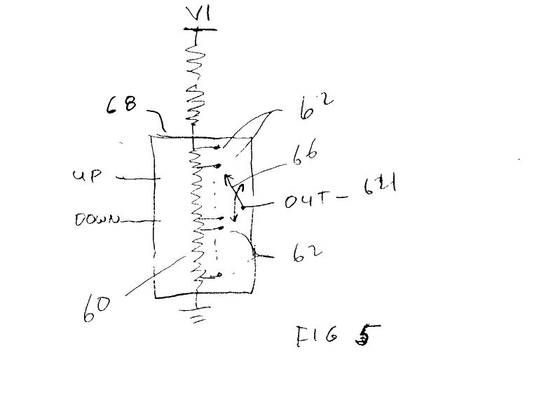

FIG. 1 shows an example of a section of a schematic with a switch for selecting various resistor values so as to set the DC Good threshold level. It will be evident to those skilled in the art to select SW1 and/or SW2 to provide a given voltage level, derived from a reference voltage, at the input 10 to the comparator 12. The three different levels are thresholds programmable by the two switches will allow for three different deviations of the DC voltage level and still produce a positive DC GOOD output. The DC input must meet the threshold in order for the comparator to produce an output indicating the DC level met specifications. In this manner the DC GOOD level can be made programmable for three different specification requirements. Of course, other switches can be used to provide more thresholds to meet other specifications. FIG. 2 shows a representative switch accessible through the housing of a power supply and covers that will prevent later changes. Those skilled in the art would now that different packaging configurations might require the PC board to be a single board or two or more small boards. FIG. 3 shows a simplified block diagram of a 5-output power supply with symbolic representation of switches for changing parameter set points. FIG. 4 is a composite circuit schematic of an embodiment of the invention. FIG. 5 shows a resistor package 68 that is programmable by a computer.

A preferred embodiment of the present invention provides a five output programmable module including two high current outputs, an additional output with a reduced current rating and two additional, lower current auxiliary outputs. The following parameter specifications apply::

1.Voltage setting The highest current voltage outputs are programmable to power logic circuits. Voltage levels typically are be 5V, 3.3V, 2.5V or 1.8 V.

2.Overvoltage Protection setting The programmable OVP circuit guarantees power supply shutdown if a fault condition results in higher than acceptable output voltage occurs. The setting is slightly above the output voltage. If the output voltage setting is changed, the OVP setting must be changed accordingly.

3. DC Good setting An output signal indicating, after power supply turnon, that all outputs have reached their desired level within specifications. The power supply contains programmable circuits which monitor each output. These monitor circuits combine for a single “DC Good signal. If a voltage setting is changed, the monitor circuit threshold for that output has to be adjusted accordingly.

4. Current Limit setting Typically an output incorporates monitor circuits such that if the output current exceeds the rating by a predetermined amount, the output, for protective reasons, is either shutdown, or limited. For example, an output rated for 70 amps might be set so that an attempt to load it to 80 amps would result in a limiting action at 75 amps. It is important to incorporate such current limiting so that the power supply is not inadvertently destroyed by load demands that are not a-short circuit but simply moderately excessive. Power supplies virtually always have short circuit protection as a separate standard characteristic. If the power supply has a virtual module intended for programmability to different voltage and power levels, it is very important to be able to change the current limit set point to guarantee performance expectations.

5.Current Share setting When voltage and current levels are changed, the ability of two identical modules to share current, when appropriately interconnected (paralleled) depends on certain analog signals exchanged between the two units. Each unit has an internal circuit which monitors output current and relates it to the specific voltage output. That circuit generates an analog signal that is compared to a similar circuit in a second unit. Each unit compares the signal from the other unit and adjusts internal operation so that the output voltages of both units are close enough to guarantee that the output currents are approximately the same. When various characteristics of a power supply are changed, the internal current share circuits must be adjusted accordingly.

6. Polarity setting It is quite common, especially for auxiliary outputs, to require negative as well as positive voltages. Such negative voltages are typically for bias voltages. Therefore it is desirable for a standard, virtual module to have provision to change output polarity.

Thus it can be seen that a single module outputting five programmable voltage outputs can be tailored to any one of thousands of combinations.

In the present invention, a module with five voltage outputs has been found to satisfy 75% or more of the market requirements. Each of the five outputs is discussed below as a virtual module or “channel.”

Channel 1 will constitute about 40% of overall power and will be set for a voltage of 1.8V, 2.5V, 3.3V or 5V. Channel-2 will constitute 30% of the power and have the same voltage options. Channel 3 will constitute 20% of the total power but have provisions for 12V, 5V or 3.3V. Channels 4 and 5 will constitute 5% of the power and have provisions for 15V down to 2.5V and polarity reversal as well.

In this preferred embodiment, channels 1, 2 and 3 are programmable using surface mounted, ultra-miniature switches on a PC board. Channels 4 and 5 polarity is programmable using subminiature switches on a PC board. Channel s4 and 5 voltages are programmable using of precision, multi turn, sealed potentiometers on a PC board. Channels 4 and 5 could incorporate switches but these auxiliary voltages are more likely to have need not only for standard voltages but also for nonstandard voltages such as 7.5V, or 9V etc. The option to use potentiometers in those channels provides an infinite adjustment capability.

While the exemplified embodiment use a certain combination of switches and pots, it would be clear to those skilled in the art that pots or switches could be interchanged in necessary for particular functions. While the exemplified embodiment use a plurality of PC boards to carry the various switches and pots, those skilled in the art could put all on a single PC board if that were compatible with the manufacturing and overall packaging scheme desired. Moreover, it is to those skilled in the art that the programmable resistor chips could be used and programmed by microprocessor or other such computer outputs, even over the Internet or other communications networks, so that the programmability of all the parameters discussed herein can be accomplished using computers.

In a preferred embodiment all of the aforementioned switches and potentiometers accessible through holes in the metallic power supply enclosure. In this manner, it is possible to take a stocked standard model, change switch or potentiometer settings in minutes with a miniature screwdriver or tool and have the new model immediately available for shipping. That is to say, an enormous number of models could be made almost instantly available from a single pretested, stocked model.

The result of this approach is that the manufacturing line need only produces a single product and the distributor needs to only stock one model. The customer, on the other hand, gets of the shelf delivery of a large variety of models. The knowledgeable customer even has the option of reprogramming the unit to different characteristics.

In practice, every possible model has associated with it a very simple set of steps as to the setting of the potentiometer or the position of the switch.

The present invention provides characteristics superior to configurable modules due to being a single “over-designed” design, e.g., lower cost, better reliability and easier programming, speed of delivery, and quicker, better and faster repair. The design, reliability, cost, performance, can be optimized with a single design with fewer components as compared to the many different designs found in prior art modules.

Some preferred embodiments of the present invention are as follows, but the invention is not limited to these forms.

A switching power supply having multiple outputs and a number of internal, but externally accessible, subminiature switches or similar mechanical programming means whereby the operation of such means alters the key operating characteristics of each of the outputs after manufacture and test of the original unit, so that the resultant configuration manifests itself as a different model with defined electrical specifications.

A switching power supply in accordance with the above in which the internal mechanical programming means allows the conversion of one model into another by changing, from one level to another in accordance with predetermined set points, output voltage, maximum current limit, overvoltage protection threshold, DC Good threshold, output voltage polarity and inter-unit current sharing proportionality scaling factor.

A switching power supply in accordance with the above in which a unit, subject to subsequent change, is always produced and tested in one configuration with mechanical programming means set in a specific position with subsequent re-programmability possible without requiring any subsequent complete or partial disassembly of the unit.

A switching power supply in accordance the above in which the external accessibility to the mechanical programming means is only with an uninstalled power supply module, with such accessibility no longer being readily available once the power supply module installed within a final enclosure.

A switching power supply in accordance with the above through 4 in switch one or more of the switches and associated programmability resistors are replaced by non volatile digital potentiometers which, like a stepping switch, can be set to predetermined resistance settings.

FIG. 5 is a detailed schematic of the virtual modules or channels of FIG. 4. Output no. 1 has five selectable parameters, each of which is controlled by a circuit primarily consisting of a comparator, reference IC's and a selector switch. Block A, B, C, D, and E, respectively, monitor and control the current limiting (i.e., maximum power), current share, voltage settings, DC Good, and Overvoltage Protection circuitry. (OVP).

Circuit A monitors the load current through sense resistors R-S, creating a signal which is compared against a fixed reference which is set by switch S-A and the related choice of three resistors. The result of the comparison is fed through an opto-coupler (not shown)_ to terminal X of the control IC and U1 and changes the pulse width of that chip so as to increase or decrease the upper limit of the pulse width thereby setting a limit on the maximum current and power.

Circuit B monitors the same current through R-S and generates a signal and compares that signal with a similarly generated signal (at point F) from a second, separate, paralleled power supply output. Then, based on that signal-to-signal comparison, there is sent a signal to point X which changes the pulse width, and therefore the output voltage, in accordance with predetermined algorithms until the internally generated signal matches the externally generated signal. That action of matching the output voltage causes the respective load currents to be approximately equal. The circuit B switch selects resistors in accordance with the required algorithms associated with the output voltage involved.

Circuit C monitors the voltage across RV in the output circuit voltage divider network. That signal is compared for correctness in Block C with a pre-determined voltage level set by the related switch and resistors and sent to an external circuit where similar signals are received from other outputs. The external circuit is configured such that if it receives a signal of correctness from each of the other monitored outputs, it generates a final signal of “DC GOOD” which can be used in the system as appropriate. If the output voltage is changed this threshold generally must be changed accordingly.

Circuit D, by means of the selectable resistors, changes the pulse width of U1 and thereby changes the output voltage. Circuit D monitors the output voltage across RV. The input from RV and the circuit D algorithms set by the selectable resistors drive a feedback loop to ensure the desired output voltage.

Circuit E also monitors the output voltage and, based on thresholds set by the comparator and references IC's within block E and the selectable resistors, sends a signal to U1 at point Z, which turns off U1 if the output voltage exceeds the proper level by a certain margin. If the output voltage is changed, this circuit generally must be changed accordingly.

Circuits A through E are shown as being repeated for outputs 2 and 3, although typically the specific settings of outputs 2 or 3 may be different.

Output 4 is an auxiliary output derived from output No. 3. It incorporated a circuit C function but not A, B, D, or E. In this section L4 is an adjustable-type linear regulator and those skilled in the art know that such regulators commonly have their output voltage set by an external resistor. Switch SL4 and the related three resistors perform that function. In this case the voltage selectability is performed differently from that of circuit C for outputs 1, 2, and 3 but the result is similar.

Output 5 is virtually identical to output 4 except that the voltage output is not shown as being monitored and sent to the DC GOOD summing circuit. Such inclusion or exclusion is a function of the specific design objectives for a particular power supply.

Outputs 4 and 5 also include switches which, acting in a double pole/double throw manner, can reverse the polarity of either output. Double pole/double throw switches are shown here but individual single pole/single throw or double throw switches can be connected to perform the same function.

Even though the above circuit description describe switches, solid state FET's, or the like, can be used to perform the same functions. As such the FET's may be controlled, as known in the art, by externally generated logic signals. Moreover, these logic signal can emanate from an external source and even by remotely set. As such the programmability of the present invention can be accomplished with one of more computer systems that may be remote from the power supplies. The remote programmability may include via the Internet or another communications network. FIG. 5 shows such an implementation. Here a linear resistor 60 is partitioned into sixty four different positions 62 each of which are connected to an output 64. UP and Down inputs are provide that increment the wiper 66 location in the direction indicated. These inputs are compatible with typical digital logic signals that can be supplied by virtually any logic or computer system.

It should be understood that above-described embodiments are being presented herein as examples and that many variations and alternatives thereof are possible. Accordingly, the present invention should be viewed broadly as being defined only as set forth in the hereinafter appended claims.

What is claimed is:

1. A programmable, switching power supply operating at a given frequency, and wherein the switching power supply meets a set of specifications for operating and storage, comprising:
a rectifier and filter that converts AC to DC,
a circuit for controlling the duty cycle of the given frequency,
a circuit for monitoring the DC output level,
a programmable resistor divider circuit coupled to the circuit for controlling the duty cycle, wherein changing the divider circuit changes the duty cycle which changes the output voltage,
a current limit circuit defining a current threshold, the current limit circuit connected to the DC output voltage,
a programmable resistor divider circuit coupled to the current limit circuit, wherein changing the divider circuit changes the current limit threshold,
an over voltage protection circuit defining a over voltage threshold, the over voltage protection circuit connected to the DC output voltage,
a programmable resistor divider circuit coupled to the over voltage protection circuit, wherein changing the divider circuit changes the duty cycle which changes the voltage threshold,
a DC good circuit defining a DC voltage threshold connected to the DC output voltage,
a programmable resistor divider circuit coupled to the DC good circuit, wherein changing the divider circuit changes the DC voltage threshold,
wherein the above programmable elements are configured to meet the specifications.

2. A switching power supply operating at a given frequency, accepting AC power input and outputting at least one DC voltage or one DC current, and wherein the switching power supply meets a set of specifications for operating and storage, and wherein at least one of the specifications is programmable, comprising:
means for programming the at least one programmable specification,
a base model of the switching power supply defined, with respect to the full range of programmability of the at least one programmable specification, wherein the operating and storage specification ratings of the base model over the full range of programmability are higher than the parameters for any other programmable configuration.

3. The switching power supply of claim 3 wherein if the base design is UL approved all the other programmable configurations are automatically UL approved.

4. The switching power supply of claim 2 wherein the at least one programmable specification comprises: at least one DC output voltage level, at least one output current level, and at least one over voltage protection level.

5. A method insuring that a programmable switching power supply meets a set of specifications for operating and storage over the range of the programmability, wherein the switching power supply operates at a given frequency, accepts AC power input and outputs at least one DC voltage or one DC current, and wherein at least one of the specifications is programmable, comprising the steps of:
programming the at least one programmable specification,
defining a base model of the switching power supply, with respect to the full range of programmability of the at least one programmable specification, wherein the operating and storage specification of the base model over the full range of programmability are as high or higher than the specifications for any other programmable configuration.

6. The method of claim 5 wherein specifications for operating and storage ratings UL specifications and all the other programmable configurations are automatically UL approved.

7. The method of claim 5 wherein the specifications for operating and storage ratings are at least one DC output voltage level, at least one output current level, and at least one over voltage protection level.

8. A method for configuring programmable switching power supply that meets a set of specifications for operating and storage over the range of the programmability, wherein the switching power supply operates at a given frequency, accepts AC power input and outputs at least one DC voltage or one DC current, comprising the steps of:
manufacturing a base model of the switching power supply, that is UL approved;
providing at least one programmable specification or parameter;
delivering the base model to a distributor;
receiving specifications generated by a user for a desired switching power supply;
configuring the at least one programmable parameter to meet the user specification; and
delivering the desired switching power supply to the user.

9. The method as defined in claim 8 wherein the at least one programmable parameter includes:
at least one output voltage;
at least one current limit;
at least one over voltage protection; and
a DC good indicator.

10. A programmable switching power supply that meets a set of specifications for operating and storage over the range of the programmability, wherein the switching power supply operates at a given frequency, accepts AC power input and outputs at least one DC voltage or one DC current, comprising:
a UL approved base model of the switching power supply;
at least one programmable specification or parameter;
means for delivering the base model to a distributor;
means for configuring the at least one programmable parameter to meet user specification; and
means for delivering the desired switching power supply to the user.

11. The switching power supply as defined in claim 10 wherein the at least one programmable parameter includes:
at least one output voltage;
at least one current limit;
at least one over voltage protection; and
a DC good indicator.
